(19) United States
(12) Patent Application Publication
(10) Pub. No.: US 2012/0062151 A1
(43) Pub. Date: Mar. 15, 2012

(54) BALL SHAPE LED LAMP

(76) Inventor: LI-YU LIN, Taipei (TW)

(21) Appl. No.: 12/883,176

(22) Filed: Sep. 15, 2010

(51) Int. Cl. H05B 37/02

(52) U.S. Cl. 315/312

(57) ABSTRACT

A ball shape LED lamp comprises a ball; a driving circuit being installed at a central portion of the ball; and an LED light assembly having a plurality of LED lamps which are retained on the surface of the ball; and all the LED lamps being electrically connected to the driving circuit. Or a retainer formed by a plurality of telescopic rods which are fixed at two ends thereof; each of two ends of the telescopic rods being retained to an inner side of a respective fixing disk; an outer side of each fixing disk being extended with a stud; and a plurality of flexible circuit strips; each of two ends of each retaining strip having a retaining hole; a plurality of LED lamps being retained to the flexible circuit strips and being spaced apart; a plurality of LED lamps being retained to the retaining flexible circuit strip.

### FIELD OF THE INVENTION

The present invention relates to LED lamps, and in particular to a ball shape LED lamp which has the effect of ball light source.

### BACKGROUND OF THE INVENTION

The conventional tungsten lamp has a core formed by winding tungsten silks. When current flowing through the silks, the tungsten will be heated and thus light up so as to have the effect of illumination. However, the conventional tungsten light consumes a large amount of power. Thus it is not suitable for current carbon reduction policy.

Currently, LED will be widely used in illumination. LEDs are mainly made from silicon cells. However, these cells emit light unidirectionally. The backside of the cell can not emit light. Thus the LED lamp radiates light at one side. This is the defect of LED lights.

### SUMMARY OF THE INVENTION

The object of the present invention is to provide a ball shape LED lamp, which can make LEDs lighting up to form as a ball light source.

To achieve above object, the present invention provides a ball shape LED lamp comprising: a ball; a driving circuit being installed at a central portion of the ball; and an LED light assembly having a plurality of LED lamps which are retained on the surface of the ball; and all the LED lamps being electrically connected to the driving circuit.

The present invention further provides a ball shape LED lamp comprising: a retainer formed by a plurality of telescopic rods which are fixed at two ends thereof; each of two ends of the telescopic rods being retained to an inner side of a respective fixing disk; an outer side of each fixing disk being extended with a stud; and a plurality of flexible circuit strips; each of two ends of each retaining strip having a retaining hole; a plurality of LED lamps being retained to the flexible circuit strips and being spaced apart; a plurality of LED lamps being retained to the retaining flexible circuit strip; wherein in assembly, the plurality of retaining strips are retained to the studs of the two retaining disks by using a nut to fix the retaining strips to the stud of the retaining disks of the retainer; all the LED lamps are electrically connected to the driving circuit.

The various objects and advantages of the present invention will be more readily understood from the following detailed description when read in conjunction with the appended drawing.

### BRIEF DESCRIPTION OF THE DRAWINGS

FIG. 1 is a partial exploded perspective view about the first embodiment of the present invention.

FIG. 2 is a perspective view about the first embodiment of the present invention.

FIG. 3 is a partial exploded perspective view about the second embodiment of the present invention.

FIG. 4 is a perspective view about the second embodiment of the present invention.

FIG. 5 is a schematic cross sectional view about the third embodiment of the present invention.

FIG. 6 is a schematic cross sectional view about the fourth embodiment of the present invention.

FIG. 7 is a schematic cross sectional view about the fifth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

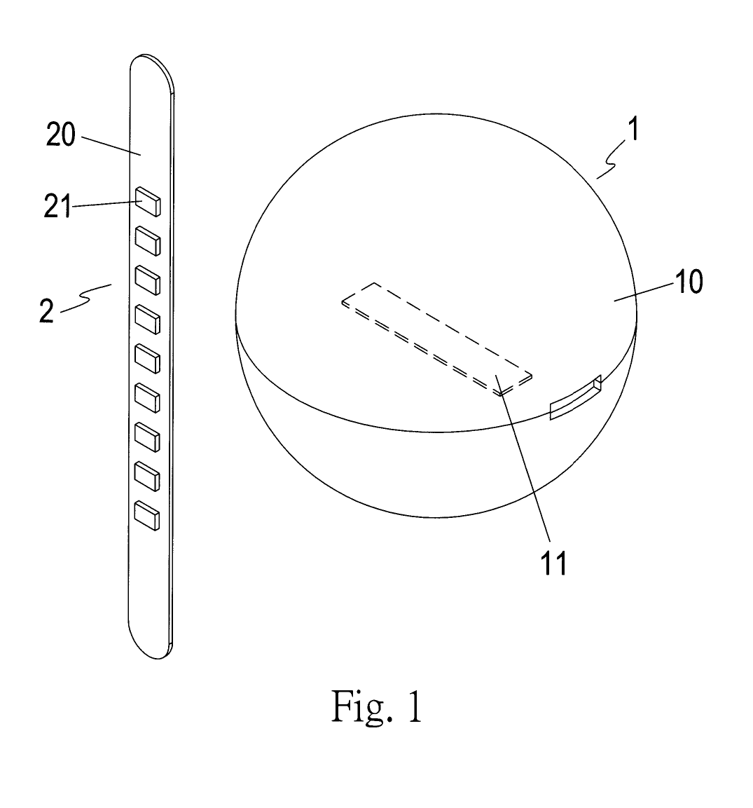

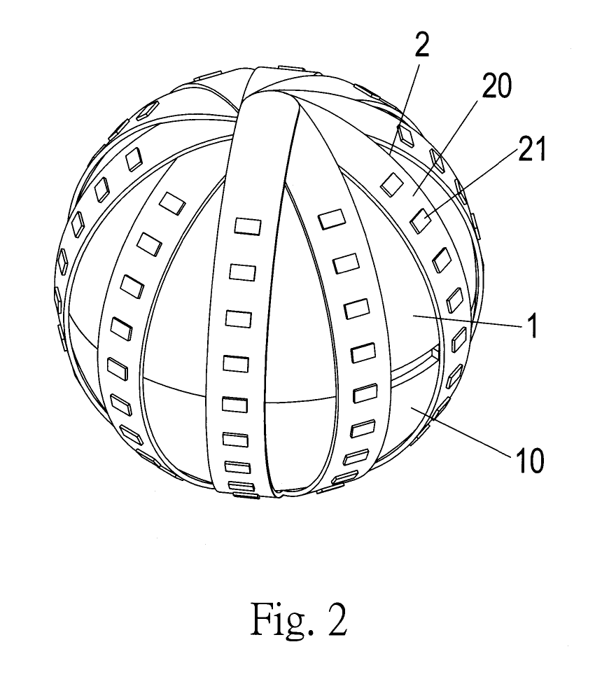

With reference to FIGS. 1 and 2, the structure of the present invention is illustrated. The present invention includes the following elements.

A ball 1 is formed by combining two hemispheres 10. A driving circuit 11 is installed at a central portion of the ball 1.

A LED light assembly 2 is formed by a plurality of flexible circuit strips 20 and a plurality of LED lamps 21. Each flexible circuit strips 20 is retained with a plurality of LED lamps 21. Each flexible circuit strip 20 is retained on the surface of the ball 1.

All the LED lamps 21 are electrically connected to the driving circuit 11.

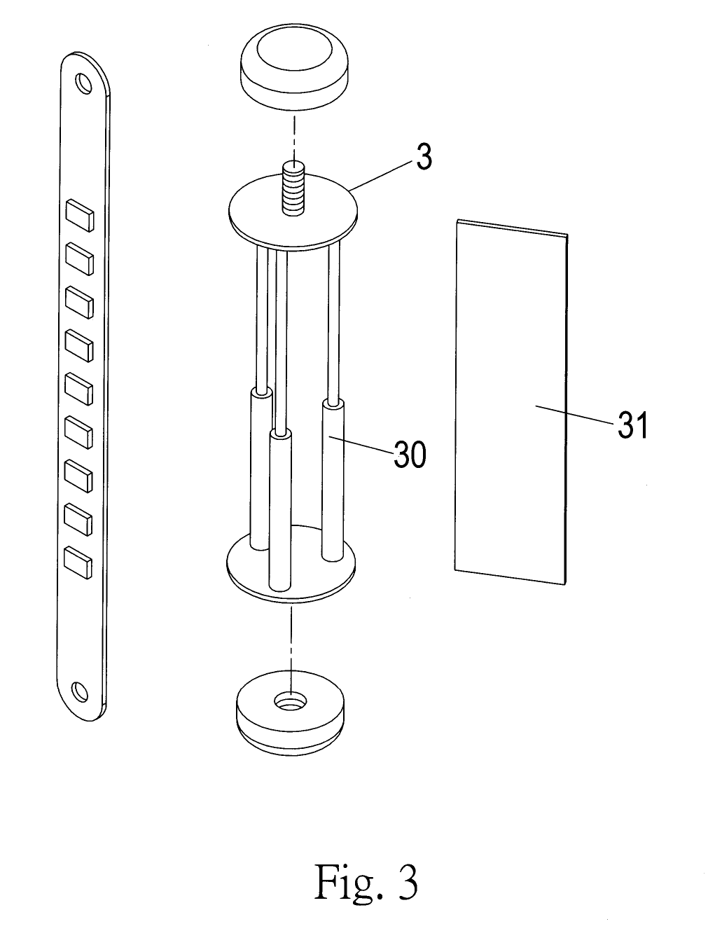

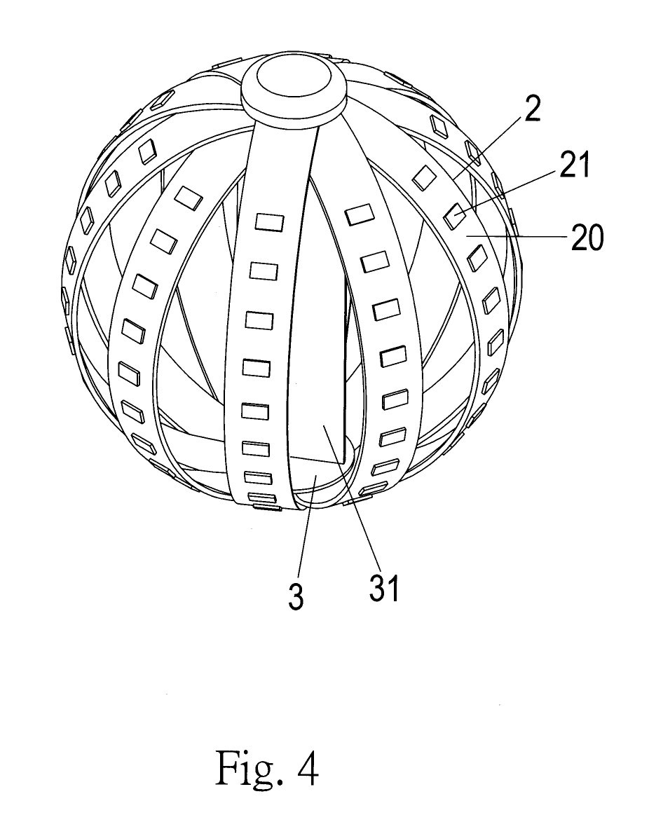

Referring to FIGS. 3 and 4, the second embodiment of the present invention is illustrated. In the second embodiment of the present invention, the structure includes the following elements.

A retainer 3 is formed by a plurality of telescopic rods 30 which are fixed at two ends thereof. Each of two ends of the telescopic rods 30 is retained to an inner side of a respective fixing disk. An outer side of each fixing disk is extended with a stud. A plurality of flexible circuit strips 2 are includes. Each of two ends of each retaining strip has a retaining hole. A plurality of LED lamps 21 are retained to the flexible circuit strips 2 and are spaced apart. A plurality of LED lamps 21 are retained to the retaining flexible circuit strip 2.

In assembly, the plurality of retaining strips 2 are retained to the studs of the two retaining disks by using a nut to fix the retaining strips 2 to the stud of the retaining disks of the retainer 31. All the LED lamps 21 are electrically connected to the driving circuit 31.

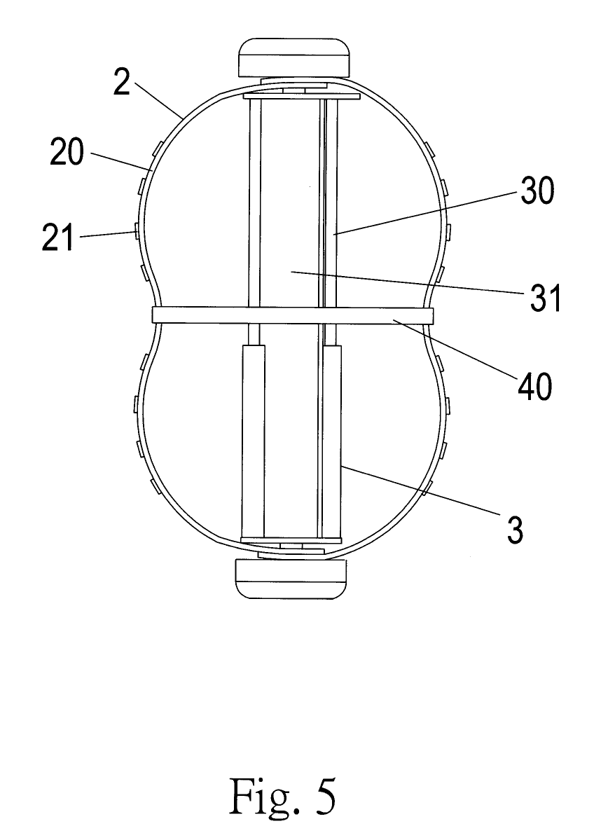

Referring to FIG. 5, the third embodiment of the present invention is illustrated. The third embodiment of the present invention is identical to the second embodiment, while a clamping strip 40 is added. Thus those identical to the second embodiment will not be described herein.

The clamp strip 40 serves to clamp the middle portion of each retaining flexible circuit strip 2 so that the whole lamp is formed as a calabash structure.

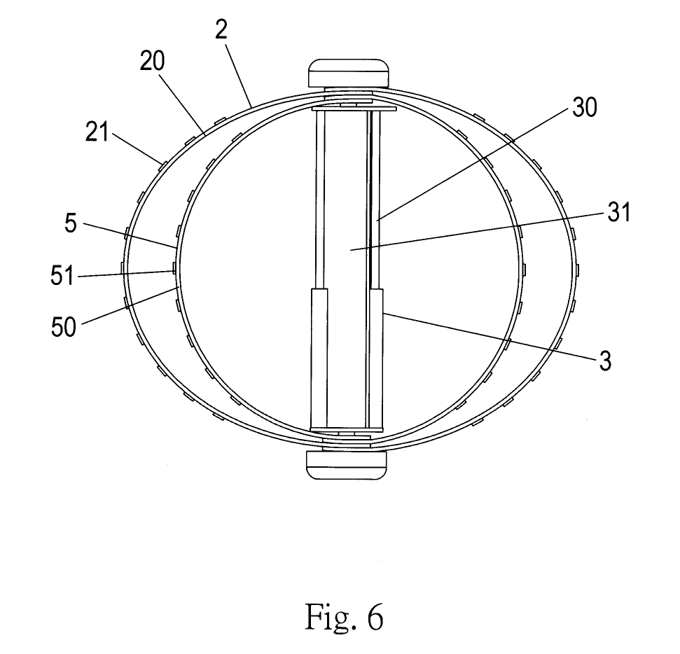

With reference to FIG. 6, the fourth embodiment of the present invention is illustrated. The third embodiment of the present invention is identical to the second embodiment. Thus those identical to the second embodiment will not be described herein. It is illustrated that in this embodiment, the flexible circuit strips 2 are formed as a two layers structure. The flexible circuit strips 2 at the inner layers are arranged as a ball shape and the flexible circuit strips 2 at the outer layers are arranged a ball shape so that the flexible circuit strips 2 are arranged as a two ball structure which are concentric.

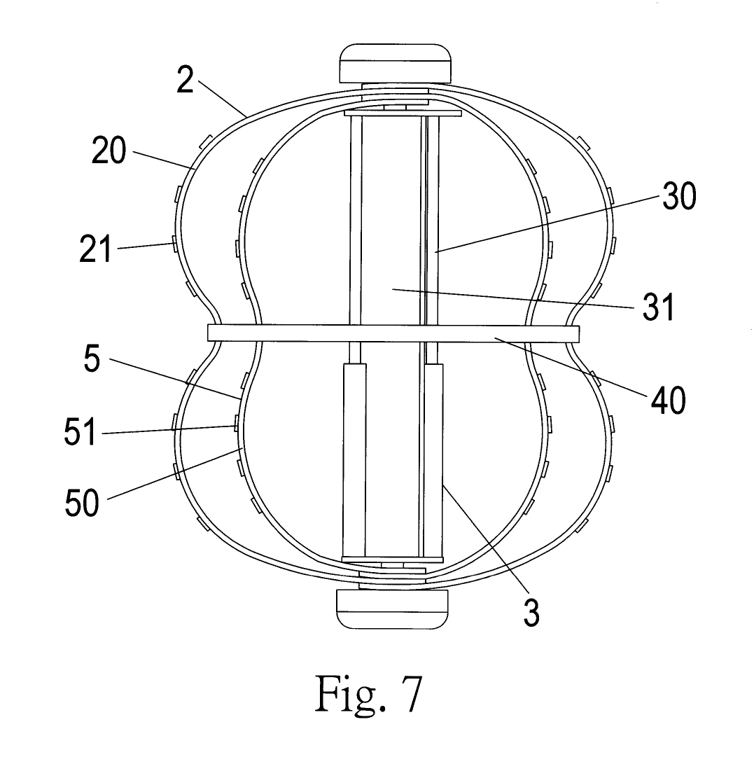

With reference to FIG. 7, the fifth embodiment of the present invention is illustrated. The third embodiment of the present invention is identical to the second embodiment, while a clamping strip 40 is added. The clamp strip 40 serves to clamp the middle portion of each retaining flexible circuit strip 2 so that the whole lamp is formed as a calabash structure. There may be two clamp strips 40 are used, one for clamping the flexible circuit strips 2 forming the inner ball and another one for clamping the flexible circuit strips 2 forming the outer ball.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A ball shape LED lamp, comprising:
a ball; a driving circuit being installed at a central portion of the ball; and
an LED light assembly having a plurality of LED lamps which are retained on the surface of the ball; and all the LED lamps being electrically connected to the driving circuit.

2. The ball shape LED lamp as claimed in claim 1, wherein the light assembly is formed by a plurality of flexible circuit strips and the plurality of LED lamps; each flexible circuit strips is retained with a plurality of LED lamps; and each flexible circuit strip is retained on the surface of the ball.

3. The ball shape LED lamp as claimed in claim 1, wherein the ball is formed by combining two hemispheres.

4. A ball shape LED lamp comprising:
a retainer formed by a plurality of telescopic rods which are fixed at two ends thereof; each of two ends of the telescopic rods being retained to an inner side of a respective fixing disk; an outer side of each fixing disk being extended with a stud; and
a plurality of flexible circuit strips; each of two ends of each retaining strip having a retaining hole; a plurality of LED lamps being retained to the flexible circuit strips and being spaced apart; a plurality of LED lamps being retained to the retaining flexible circuit strip;
wherein in assembly, the plurality of circuit strips are retained to the studs of the two retaining disks by using a nut to fix the circuit strips to the stud of the retaining disks of the retainer; all the LED lamps are electrically connected to the driving circuit.

5. The ball shape LED lamp as claimed in claim 4, wherein a clamp strip serves to clamp middle portions of each retaining flexible circuit strip so that the whole lamp is formed as a calabash structure.

6. The ball shape LED lamp as claimed in claim 4, wherein the flexible circuit strips are formed as a two layers structure; a part of the flexible circuit strips at the inner layers are arranged as a ball shape and the other part of the flexible circuit strips at the outer layers are arranged a ball shape so that the flexible circuit strips are arranged as a two ball structure which are concentric.

7. The ball shape LED lamp as claimed in claim 6, wherein two clamp strips are used, one for clamping the flexible circuit strips forming the inner ball and another one for clamping the flexible circuit strips forming the outer ball.
